(19) United States
(12) Patent Application Publication
(10) Pub. No.: US 2015/0001287 A1
(43) Pub. Date: Jan. 1, 2015

(54) METHOD, APPARATUS, AND MOBILE TERMINAL FOR OBTAINING INFORMATION

(71) Applicant: TENCENT TECHNOLOGY (SHENZHEN) COMPANY LIMITED, Shenzhen (CN)

(72) Inventors: Xiangping ZHONG, Shenzhen (CN); Sha MO, Shenzhen (CN)

(21) Appl. No.: 14/479,004

(22) Filed: Sep. 5, 2014

Related U.S. Application Data
(63) Continuation of application No. PCT/CN2013/071692, filed on Feb. 20, 2013.

(30) Foreign Application Priority Data
Mar. 12, 2012 (CN) 201210063683.6

(51) Int. Cl. G06F 17/30

(52) U.S. Cl. CPC G06F 17/30879; G06F 17/30887; G06F 17/30864
USPC 235/375

(57) ABSTRACT

Examples of the present disclosure provide a method, an apparatus, and a mobile terminal for obtaining information, and belong to a communication technology field. The method includes: enabling a function for scanning a two-dimensional code; obtaining a resource request; performing, based on the resource request, a resource-locating operation to locate requested resource information; and obtaining the located resource information. By this manner, a user does not need to manually input any information in a browser, and the browser may perform the resource-locating operation based on the resource request obtained through scanning the two-dimensional code. As such, operations of the browser may be simplified and the accuracy and efficiency of input may be improved.

### CROSS-REFERENCE TO RELATED APPLICATIONS

This application is a continuation of International Patent Application No. PCT/CN2013/071692, filed Feb. 20, 2013, which claims the benefit of and priority to Chinese Patent Application No. 201210063683.6, filed Mar. 12, 2012. The entire disclosures of each of the above applications are incorporated herein by reference.

### FIELD

Examples of the present disclosure relate to a communication technology field, and more particularly, to a method, an apparatus, and a mobile terminal for obtaining information.

### BACKGROUND

With widespread utilization of a mobile terminal, a user may perform some operations through a browser, such as browsing a web page or searching a keyword. As such, the user may obtain required information anytime.

In a conventional browser of the mobile terminal, the user needs to manually input a uniform resource locator (URL) of the web page to be browsed, or to manually input the keyword to be searched. Then, the browser may search based on the information inputted by the user and display a search result on an interface of the mobile terminal.

During the process of implementing examples of the present disclosure, an inventor finds that the prior art at least has the following deficiencies, e.g., the user needs to input the information manually, such as the URL of the web page, the keyword to be searched, etc. As such, operations of manual input may be tedious, time-consuming, and easy to result in an error, and thus experience of the user when using the browser of the mobile terminal may be greatly reduced.

### SUMMARY

According to an aspect of the present disclosure, a method for obtaining information is provided. The method includes:
monitoring an entry for scanning a two-dimensional code;
upon a triggering message associated with the entry is received, enabling a function for scanning the two-dimensional code;
scanning the two-dimensional code;
parsing the two-dimensional code to obtain a resource request carried by the two-dimensional code;
performing, based on the resource request, a resource-locating operation to locate requested resource information; and
obtaining the requested resource information.

According to another aspect of the present disclosure, an apparatus for obtaining information is provided. The apparatus includes:
a resource requesting module, configured to monitor an entry for scanning a two-dimensional code; upon a triggering message associated with the entry is received, enable a function for scanning the two-dimensional code, and obtain a resource request carried by the two-dimensional code;
a resource locating module, configured to perform, based on the resource request, a resource-locating operation to locate requested resource information; and
a resource obtaining module, configured to obtain the requested resource information;
wherein the resource requesting module includes:
a scanning unit, configured to scan the two-dimensional code; and
a parsing unit, configured to parse the two-dimensional code to obtain the resource request.

According to still another aspect of the present disclosure, a mobile terminal is provided. The mobile terminal includes an apparatus for obtaining information, which is configured to
monitor an entry for scanning a two-dimensional code,
upon a triggering message associated with the entry is received, enable a function for scanning the two-dimensional code,
obtain a resource request carried by the two-dimensional code,
perform, based on the resource request, a resource-locating operation to locate requested resource information, and
obtain the requested resource information;
wherein the apparatus is further configured to scan the two-dimensional code and parse the two-dimensional code to obtain the resource request.

According to still another aspect of the present disclosure, a non-transitory computer-readable storage medium encoded with a plurality of instructions is provided. When the instructions are executed by one or more computers cause the one or more computers to perform operations including:
monitoring an entry for scanning a two-dimensional code;
upon a triggering message associated with the entry is received, enabling a function for scanning the two-dimensional code;
scanning the two-dimensional code;
parsing the two-dimensional code to obtain a resource request carried by the two-dimensional code;
performing, based on the resource request, a resource-locating operation to locate requested resource information; and
obtaining the requested resource information.

When examples of the present disclosure are employed, a function for scanning a two-dimensional code may be enabled; a resource request may be obtained; a resource-locating operation may be performed, based on the resource request, to locate resource information requested; and the located resource information may be obtained. By this manner, a user does not need to manually input any information in a browser, and the browser may perform the resource-locating operation based on the resource request obtained through scanning the two-dimensional code. As such, operations of the browser may be simplified and the accuracy and efficiency of input may be improved.

### BRIEF DESCRIPTION OF THE DRAWINGS

Hereinafter, accompanying drawings used to describe examples of the present disclosure may be briefly introduced to make the technical solution of the present disclosure clearer. Obviously, the drawings described below may be some example embodiments of the present disclosure. According to these drawings, those skilled in the art may also obtain other drawings without making creative efforts.

FIG. 1 is a flowchart illustrating a method for obtaining information, according to a first example of the present disclosure.

FIG. 2 is a flowchart illustrating a method for obtaining information, according to a second example of the present disclosure.

FIG. 3 is a flowchart illustrating a method for obtaining information, according to a third example of the present disclosure.

FIG. 4 is a schematic diagram illustrating a structure of an apparatus for obtaining information, according to a fourth example of the present disclosure.

FIG. 5 is a schematic diagram illustrating a structure of another apparatus for obtaining information, according to a fourth example of the present disclosure.

### DETAILED DESCRIPTION

Hereinafter, the present disclosure will be described in further detail with reference to the accompanying drawings and examples.

Currently, a two-dimensional code may be included in data information such as a digital advertisement of a website, an offline print advertisement, a corporation business-card, a personal brochure, and a software promotion page. The two-dimensional code may carry information like a URL, an issue address of a software installation package, a corporation keyword, etc. According to examples of the present disclosure, during the process of developing a browser of a mobile terminal, an application for scanning a two-dimensional code may be built in the browser. As such, the browser itself may have a capability for scanning and obtaining a two-dimensional code. In this case, a user may simply enter the application for scanning the two-dimensional code, which is in the browser, to obtain the information carried by the two-dimensional code, and may search the information without manually inputting any information, therefore the time consumed by the user for inputting the URL in the browser may be saved.

According to an example of the present disclosure, an apparatus for obtaining information may include the browser but not be limited thereto, examples of the present disclosure may not limit herein.

### A First Example

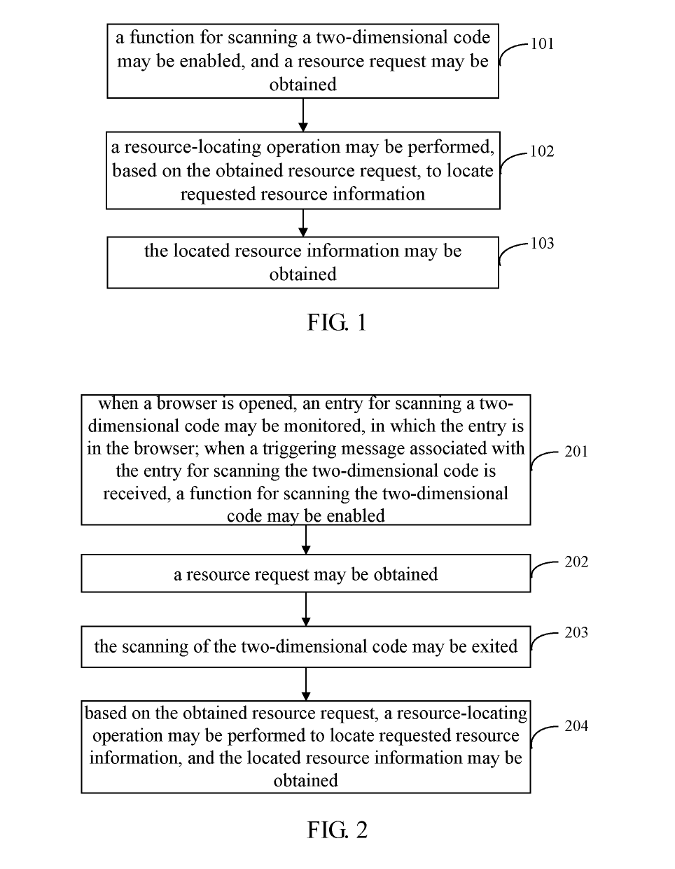

As shown in FIG. 1, according to the first example of the present disclosure, a method for obtaining information may be provided. The method may include the following operations.

In block 101, a function for scanning a two-dimensional code may be enabled, and a resource request may be obtained.

In block 102, a resource-locating operation may be performed, based on the obtained resource request, to locate requested resource information.

In block 103, the located resource information may be obtained.

In an example, the operation of enabling the function for scanning the two-dimensional code may include:

monitoring an entry for scanning the two-dimensional code, in which the entry is in a browser; and

when a triggering message associated with the entry for scanning the two-dimensional code is received, enabling the function for scanning the two-dimensional code.

In an example, the operation of enabling the function for scanning the two-dimensional code may include:

monitoring a shortcut entry for scanning the two-dimensional code, in which the shortcut entry is on a user interface; and

when a triggering message associated with the shortcut entry for scanning the two-dimensional code is received, enabling the function for scanning the two-dimensional code.

In an example, the resource request may include at least one of a URL of a requested web page, a downloading address of requested resources, and text information.

Preferably, the operation of obtaining the resource request may include:

scanning a two-dimensional code to be scanned to obtain the two-dimensional code; and

parsing the two-dimensional code to obtain the resource request carried by the two-dimensional code.

In an example, before the operation of performing, based on the obtained resource request, the resource-locating operation, the method may further include:

exiting the scanning of the two-dimensional code.

In an example, the operation of performing, based on the obtained resource request, the resource-locating operation to locate the requested resource information may include:

if the resource request includes the URL of the requested web page, obtaining, based on the URL, a request for sending a web page from a server, and locating web page data associated with the URL; and/or

if the resource request includes the downloading address of the requested resources, querying the server for the downloading address, and locating downloading resources associated with the downloading address; and/or

if the resource request includes the text information, opening a local search engine, inputting the text information to the search engine for searching, and locating a search result.

When examples of the present disclosure are employed, a function for scanning a two-dimensional code may be enabled; a resource request may be obtained; a resource-locating operation may be performed, based on the obtained resource request, to locate resource information requested; and the located resource information may be obtained. By this manner, the user does not need to manually input any information in a browser, and the browser may perform the resource-locating operation based on the resource request obtained through scanning the two-dimensional code. As such, operations of the browser may be simplified and the accuracy and efficiency of input may be improved.

### A Second Example

As shown in FIG. 2, according to the second example of the present disclosure, a method for obtaining information may be provided. The method may include the following operations.

In block 201, when a browser is opened, an entry for scanning a two-dimensional code may be monitored, in which the entry is in the browser; when a triggering message associated with the entry for scanning the two-dimensional code is received, a function for scanning the two-dimensional code may be enabled.

In the example, the function for scanning the two-dimensional code may be integrated in the browser, and the entry for scanning the two-dimensional code may be configured in a web page of the browser. In an example, the entry for scanning the two-dimensional code may be configured in a main interface of the browser. Alternatively, the entry for scanning the two-dimensional code may be configured in a web page that is independently configured. Specific implementation may not be limited by examples of the present disclosure. In this case, when the browser is opened, a result for scanning the two-dimensional code may be monitored in real time. When the triggering message associated with the entry for scanning the two-dimensional code is received, the scanning of the two-dimensional code may be enabled.

In this case, when a user needs to scan the two-dimensional code, the user may open the browser in the mobile terminal and click on the entry for scanning the two-dimensional code. When the entry for scanning the two-dimensional code is clicked on, the terminal device may receive the triggering message associated with the entry for scanning the two-dimensional code, and may execute the application for scanning the two-dimensional code without separately installing an application for scanning the two-dimensional code in the mobile terminal, and thus it is convenient for the user.

Further, the two-dimensional code to be scanned may be stored in a storage unit of the terminal device where the browser is in, or may be stored in a medium independent of the terminal device.

According to an example of the present disclosure, the mobile terminal may include a mobile phone or other handheld devices having a camera function, which may not be limited by examples of the present disclosure.

In block 202, a resource request may be obtained.

According to an example of the present disclosure, when the scanning of the two-dimensional code is enabled, a photo view of a camera may be appeared on an interface of the mobile terminal The two-dimensional code may be placed in a viewfinder of the view and a viewing distance may be adjusted to wait for the completion of the scanning. Specifically, the operation of obtaining the resource request may include scanning the two-dimensional code to be scanned to obtain the two-dimensional code, and parsing the two-dimensional code to obtain the resource request carried by the two-dimensional code. In an example, the operation of scanning the two-dimensional code may include clicking on a photo button to take a photograph of the two-dimensional code so as to obtain the photograph of the two-dimensional code. And then the photograph may further be parsed. Or in another example, the two-dimensional code may not be photoed, rather, the two-dimensional code may be placed in the viewfinder of the camera in the mobile terminal, and a preset period may be waited to complete the scanning of the two-dimensional code. In this case, the preset period may be 0.5 seconds, 1 second, 1.5 seconds, or 3 seconds, etc., which may not be limited by examples of the present disclosure.

Further, when the scanning of the two-dimensional code is enabled, the user of the terminal device may select the two-dimensional code to be scanned from the storage unit of the terminal device, and may scan the stored two-dimensional code. Examples of the present disclosure may not limit a source of the stored two-dimensional code. The two-dimensional code may be downloaded from a web page by the user, or may be sent by another user to the terminal device.

According to an example of the present disclosure, an encoding format of the two-dimensional code may include but may not be limited to at least one of UPC-A and UPC-E, EAN-8 and EAN-13, Code 39, Code 93, Code 128, QR Code , ITF, Codabar, RSS-14 (all variants), Data Matrix, PDF 417 (‘alpha’ quality), Aztec (‘alpha’ quality). In this case, each encoding format may correspond to a decoding format. When an image of the two-dimensional code is obtained, the two-dimensional code may be analyzed to obtain an encoding mode of the two-dimensional code, and a corresponding decoding mode may be found to parse the two-dimensional code, so as to obtain the information carried by the two-dimensional code. The process of parsing the two-dimensional code may refer to the prior art, which may not be repeated herein.

According to an example of the present disclosure, the resource request may include but may not be limited to at least one of a URL of a requested web page, a downloading address of requested resources, and text information, which may not be limited by examples of the present disclosure.

In block 203, the scanning of the two-dimensional code may be exited.

In an example, when the resource request of the two-dimensional code is obtained, the browser may exit the application for scanning the two-dimensional code, i.e., a camera mode may be exited, so that resources of the mobile terminal may be saved, such as saving power of the mobile terminal, and other processes of the browser may be accelerated.

It should be noted that the operation in block 203 may be optional. During the practical implementation process, the camera mode may not be exited. When the browser executes another application, the application for scanning the two-dimensional code may still be enabled, which may not be limited by examples of the present disclosure.

In block 204, based on the obtained resource request, a resource-locating operation may be performed to locate requested resource information, and the located resource information may be obtained.

In this case, the resource locating may be defined to mean to obtain network resources associated with the resource request carried by the two-dimensional code. For example, when the resource request carried by the two-dimensional code is the URL, the browser may locate, based on the URL, web page resources to which the URL points, and then obtain the web page resources. When the resource request carried by the two-dimensional code is the downloading address of the resources, the browser may locate, based on the downloading address, network resources to which the downloading address points, and then obtain the network resources. When the resource request carried by the two-dimensional code is the text information, the browser may locate, based on the text information, network resources to which the text information points, and then obtain the network resources.

In an example, a type of the resource-locating operation may be varied according to a type of the information included in the obtained resource request. When the resource request is the URL, the resource-locating operation may include opening the web page associated with the resource request, i.e., locating, based on the URL, the web page resources to which the URL points, and subsequently the web page resources may be obtained. When the resource request is the downloading address, the resource-locating operation may include downloading the resources associated with the resource request, i.e., locating, based on the downloading address, the network resources to which the downloading address points, and subsequently the network resources may be obtained. When the resource request is the text information, the resource-locating operation may include searching the resources associated with the source request, i.e., locating, based on the text information, the network resources to which the text information points, and subsequently the network resources may be obtained.

Specifically, the operation of performing, based on the obtained resource request, the resource-locating operation to locate the requested resource information may include:

if the resource request includes the URL of the requested web page, obtaining, based on the URL, a request for sending a web page from a server, and locating web page data associated with the URL; and/or

if the resource request includes the downloading address of the requested resources, querying the server for the downloading address, and locating the downloading resources associated with the downloading address, in which the downloading resources may include but may not be limited to a picture, a video, a music, software, etc., which may not be limited by examples of the present disclosure; and/or

if the resource request includes the text information, opening a local search engine, inputting the text information to the search engine for searching, and locating a search result.

For example, if a result of scanning a two-dimensional code is “National People's Congress and Chinese People's Political Consultative Conference (NPC&CPPCC)”, a local SoSo™ or Baidu™ search page may be opened, and text contents carried by the two-dimensional code may be inputted to the search page when the search page is opened. As such, the SoSo™ or Baidu™ may search for the text contents, and a final result for searching for the “NPC&CPPCC” may be presented on a web page for viewing by the user.

When examples of the present disclosure are employed, a function for scanning a two-dimensional code may be enabled; a resource request may be obtained; a resource-locating operation may be performed, based on the obtained resource request, to locate resource information requested; and the located resource information may be obtained. By this manner, the user does not need to manually input any information in a browser, and the browser may perform the resource-locating operation based on the resource request obtained through scanning the two-dimensional code. As such, operations of the browser may be simplified and the accuracy and efficiency of input may be improved. Moreover, an address of downloaded resources or text information carried by the two-dimensional code may be located, and the user therefore may quickly and conveniently obtain information via the mobile terminal, and thus the experience of the user when using the browser of the mobile terminal may be improved. Further, the scanning of the two-dimensional code may be exited before performing the resource-locating operation based on the obtained resource request, thus resources of the mobile terminal may be saved and performance of the browser may be improved.

### A Third Example

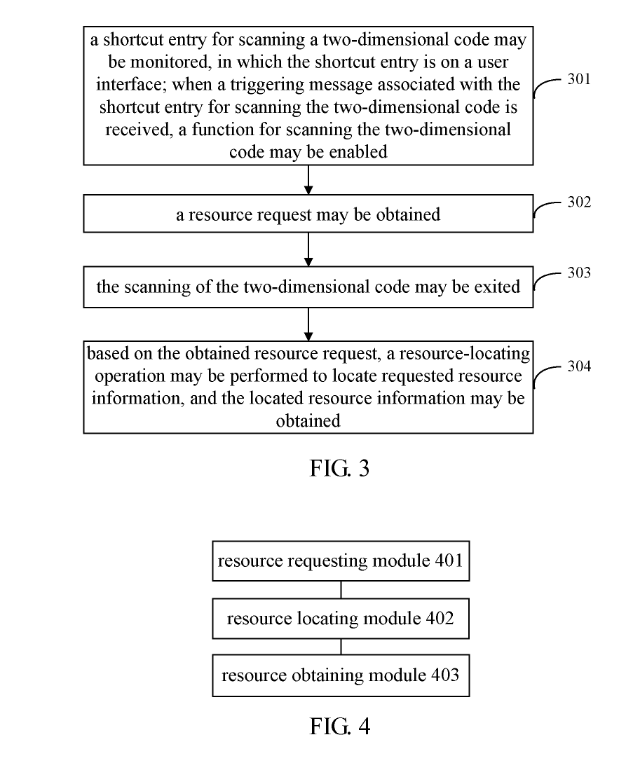

As shown in FIG. 3, according to the third example of the present disclosure, a method for obtaining information may be provided. In this case, on the basis of integrating a function for scanning a two-dimensional code in a browser, in order to further facilitate the use of the user, when the browser is installed, a shortcut entry for scanning the two-dimensional code may be created on a user interface (i.e., a desktop of a mobile terminal), such as a shortcut icon, which may be configured as an entry of an application for scanning the two-dimensional code. The user may directly click on the shortcut icon on the desktop to enable scanning of the two-dimensional code. When the scanning is successful, the browser may be called to perform a browsing operation or a searching operation. During implementation, the method may include operations in blocks 301-304, in which the operations in the blocks 302-304 may be the same as those in the blocks 202-204, as described in the second example, which may not be repeated herein. What is different from the second example may be the operation in block 301.

In block 301, a shortcut entry for scanning a two-dimensional code may be monitored, in which the shortcut entry is on a user interface; when a triggering message associated with the shortcut entry for scanning the two-dimensional code is received, a function for scanning the two-dimensional code may be enabled.

In the example, when the browser is installed, the shortcut entry for scanning the two-dimensional code may be created on the desktop of the mobile terminal simultaneously, such as a shortcut icon. In this case, the desktop of the mobile terminal may be the user interface. The browser may monitor the shortcut entry in real time. When the user clicks on the shortcut icon for scanning the two-dimensional code, which is on the user interface, the browser may receive the triggering message associated with the shortcut entry for scanning the two-dimensional code and enable the function for scanning the two-dimensional code.

When examples of the present disclosure are employed, a function for scanning a two-dimensional code may be enabled; a resource request may be obtained; a resource-locating operation may be performed, based on the obtained resource request, to locate resource information requested; and the located resource information may be obtained. By this manner, the user does not need to manually input any information in a browser, and the browser may perform the resource-locating operation based on the resource request obtained through scanning the two-dimensional code. As such, operations of the browser may be simplified and the accuracy and efficiency of input may be improved. Moreover, an address of downloaded resources or text information carried by the two-dimensional code may be located, and the user therefore may quickly and conveniently obtain information via the mobile terminal, and thus the experience of the user when using the browser of the mobile terminal may be improved. Further, the scanning of the two-dimensional code may be exited before performing the resource-locating operation based on the obtained resource request, thus resources of the mobile terminal may be saved and performance of the browser may be improved. And, according to the example of the present disclosure, a shortcut icon for scanning the two-dimensional code may be created on the desktop of the mobile terminal, so that when the user needs to scan the two-dimensional code, the use may quickly open the shortcut for scanning. As such, the time consumed by the user for opening the browser and then entering the application for scanning the two-dimensional code may be saved, and the experience of the user when using the browser of the mobile terminal may further be improved.

### A Fourth Example

As shown in FIG. 4, according to the fourth example of the present disclosure, an apparatus for obtaining information may be provided. The apparatus may include a resource requesting module 401, a resource locating module 402, and a resource obtaining module 403, in which:

the resource requesting module 401 may enable a function for scanning a two-dimensional code, and obtain a resource request;

the resource locating module 402 may perform, based on the obtained resource request, a resource-locating operation to locate requested resource information; and

the resource obtaining module 403 may obtain the located resource information.

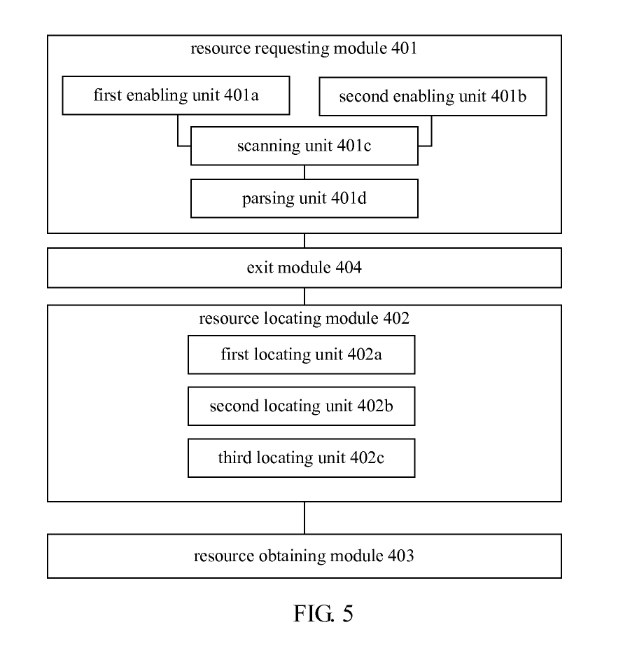

In an example, as shown in FIG. 5, the resource requesting module 401 may include:

a first enabling unit 401a, to monitor an entry for scanning the two-dimensional code, in which the entry is in a browser; and when a triggering message associated with the entry for scanning the two-dimensional code is received, enable the function for scanning the two-dimensional code.

In an example, as shown in FIG. 5, the resource requesting module 401 may include:

a second enabling unit 401b, to monitor a shortcut entry for scanning the two-dimensional code, in which the shortcut entry is on a user interface; and when a triggering message associated with the shortcut entry for scanning the two-dimensional code is received, enable the function for scanning the two-dimensional code.

In an example, the resource request may include at least one of a URL of a requested web page, a downloading address of requested resources, and text information.

In an example, as shown in FIG. 5, the resource requesting module 401 may include:

a scanning unit 401c, to scan a two-dimensional code to be scanned to obtain the two-dimensional code; and

a parsing unit 401d, to parse the two-dimensional code to obtain the resource request carried by the two-dimensional code.

In an example, as shown in FIG. 5, the apparatus may further include an exit module 404, to exit the scanning of the two-dimensional code before the resource locating module 402 performs the resource-locating operation.

In an example, as shown in FIG. 5, the resource locating module 402 may include:

a first locating unit 402a, to obtain, if the resource request includes the URL of the requested web page, a request for sending a web page from a server based on the URL, and locate web page data associated with the URL; and/or

a second locating unit 402b, to query, if the resource request includes the downloading address of the requested resources, the server for the downloading address, and locate downloading resources associated with the downloading address; and/or

a third locating unit 402c, to open a local search engine if the resource request includes the text information, input the text information to the search engine for searching, and locate a search result.

According to an example of the present disclosure, a mobile terminal may be provided. The mobile terminal may include the apparatus for obtaining information as described above.

When examples of the present disclosure are employed, a function for scanning a two-dimensional code may be enabled; a resource request may be obtained; a resource-locating operation may be performed, based on the obtained resource request, to locate resource information requested; and the located resource information may be obtained. By this manner, the user does not need to manually input any information in a browser, and the browser may perform the resource-locating operation based on the resource request obtained through scanning the two-dimensional code. As such, operations of the browser may be simplified and the accuracy and efficiency of input may be improved.

The apparatus and the mobile terminal provided by the examples of the present disclosure may belong to the same concept as the method examples, implementation of which may referred to the aforementioned method examples, which may not be repeated herein.

Those skilled in the art may understand that all or part of the procedures of the methods of the above examples may be implemented by hardware, or by hardware modules following machine readable instructions. The machine readable instructions may be stored in a computer readable storage medium. The storage medium may be read-only memory (ROM), diskette, or compact disc (CD), and etc.

The above are several examples of the present disclosure, and are not used for limiting the protection scope of the present disclosure. Any modifications, equivalents, improvements, etc., made under the principle of the present disclosure should be included in the protection scope of the present disclosure.

What is claimed is:

1. A method for obtaining information, comprising:
monitoring an entry for scanning a two-dimensional code;
upon a triggering message associated with the entry is received, enabling a function for scanning the two-dimensional code;
scanning the two-dimensional code;
parsing the two-dimensional code to obtain a resource request carried by the two-dimensional code;
performing, based on the resource request, a resource-locating operation to locate requested resource information; and
obtaining the requested resource information.

2. The method of claim 1, wherein the entry is in a browser.

3. The method of claim 1, wherein the entry is a shortcut entry for scanning the two-dimensional code, and the shortcut entry is on a user interface; and
the operation of enabling the function for scanning the two-dimensional code comprises:
when a triggering message associated with the shortcut entry is received, enabling the function for scanning the two-dimensional code.

4. The method of claim 1, wherein the resource request comprises at least one of a uniform resource locator (URL) of a requested web page, a downloading address of requested resources, and text information.

5. The method of claim 1, wherein before the operation of performing, based on the resource request, the resource-locating operation, the method further comprises:
exiting the function for scanning the two-dimensional code.

6. The method of claim 4, wherein the operation of performing, based on the resource request, the resource-locating operation to locate the requested resource information comprises at least one of:
if the resource request comprises the URL of the requested web page, obtaining, based on the URL, a request for sending a web page from a server, and locating web page data associated with the URL;
if the resource request comprises the downloading address of the requested resources, querying the server for the downloading address, and locating downloading resources associated with the downloading address; and
if the resource request comprises the text information, opening a local search engine, inputting the text information to the search engine for searching, and locating a search result.

7. An apparatus for obtaining information, comprising:
a resource requesting module, configured to monitor an entry for scanning a two-dimensional code; upon a triggering message associated with the entry is received, enable a function for scanning the two-dimensional code, and obtain a resource request carried by the two-dimensional code;
a resource locating module, configured to perform, based on the resource request, a resource-locating operation to locate requested resource information; and
a resource obtaining module, configured to obtain the requested resource information;
wherein the resource requesting module comprises:
a scanning unit, configured to scan the two-dimensional code; and
a parsing unit, configured to parse the two-dimensional code to obtain the resource request.

8. The apparatus of claim 7, wherein the entry is in a browser, the resource requesting module comprises:
a first enabling unit, configured to
monitor the entry in the browser; and
when the triggering message associated with the entry is received, enable the function for scanning the two-dimensional code.

9. The apparatus of claim 7, wherein the entry is a shortcut entry for scanning the two-dimensional code, and the shortcut entry is on a user interface;
the resource requesting module comprises:
a second enabling unit, configured to
monitor the shortcut entry; and
when a triggering message associated with the shortcut entry is received, enable the function for scanning the two-dimensional code.

10. The apparatus of claim 7, wherein the resource request comprises at least one of a uniform resource locator (URL) of a requested web page, a downloading address of requested resources, and text information.

11. The apparatus of claim 7, further comprising:
an exit module, configured to exit the function for scanning the two-dimensional code before the resource locating module performs the resource-locating operation.

12. The apparatus of claim 10, wherein the resource locating module comprises at least one of:
a first locating unit, configured to obtain, if the resource request comprises the URL of the requested web page, a request for sending a web page from a server based on the URL, and locate web page data associated with the URL;
a second locating unit, configured to query, if the resource request comprises the downloading address of the requested resources, the server for the downloading address, and locate downloading resources associated with the downloading address; and
a third locating unit, configured to open a local search engine if the resource request comprises the text information, input the text information to the search engine for searching, and locate a search result.

13. A mobile terminal, comprising an apparatus for obtaining information, wherein the apparatus is configured to
monitor an entry for scanning a two-dimensional code,
upon a triggering message associated with the entry is received, enable a function for scanning the two-dimensional code,
obtain a resource request carried by the two-dimensional code,
perform, based on the resource request, a resource-locating operation to locate requested resource information, and
obtain the requested resource information;
wherein the apparatus is further configured to scan the two-dimensional code and parse the two-dimensional code to obtain the resource request.

14. A non-transitory computer-readable storage medium encoded with a plurality of instructions that when executed by one or more computers cause the one or more computers to perform operations comprising:
monitoring an entry for scanning a two-dimensional code;
upon a triggering message associated with the entry is received, enabling a function for scanning the two-dimensional code;
scanning the two-dimensional code;
parsing the two-dimensional code to obtain a resource request carried by the two-dimensional code;
performing, based on the resource request, a resource-locating operation to locate requested resource information; and
obtaining the requested resource information.

15. The non-transitory computer-readable storage medium of claim 14, wherein the entry is in a browser.

16. The non-transitory computer-readable storage medium of claim 14, wherein the entry is a shortcut entry for scanning the two-dimensional code, and the shortcut entry is on a user interface;
the operation of enabling the function for scanning the two-dimensional code comprises:
when a triggering message associated with the shortcut entry is received, enabling the function for scanning the two-dimensional code.

17. The non-transitory computer-readable storage medium of claim 14, wherein the resource request comprises at least one of a uniform resource locator (URL) of a requested web page, a downloading address of requested resources, and text information.

18. The non-transitory computer-readable storage medium of claim 14, comprising instructions that cause the one or more computers to perform operations comprising:
exiting the function for scanning the two-dimensional code before performing the resource-locating operation based on the resource request.

19. The non-transitory computer-readable storage medium of claim 17, wherein the operation of performing, based on the resource request, the resource-locating operation to locate the requested resource information comprises at least one of:
if the resource request comprises the URL of the requested web page, obtaining, based on the URL, a request for sending a web page from a server, and locating web page data associated with the URL;
if the resource request comprises the downloading address of the requested resources, querying the server for the downloading address, and locating downloading resources associated with the downloading address; and
if the resource request comprises the text information, opening a local search engine, inputting the text information to the search engine for searching, and locating a search result.
